(19) United States
(12) Patent Application Publication
(10) Pub. No.: US 2024/0179826 A1
(43) Pub. Date: May 30, 2024

(54) PLASMA TORCH DEVICE COMPONENT MONITORING

(71) Applicant: Edwards Limited, Burgess Hill, Sussex (GB)

(72) Inventors: Gary Peter Knight, Clevedon Somerset (GB); Erik Wagenaars, York Yorkshire (GB); Neil Condon, Burgess Hill Sussex (GB); Simone Magni, Clevedon Somerset (GB)

(21) Appl. No.: 18/553,417

(22) PCT Filed: Mar. 30, 2022
(86) PCT No.: PCT/GB2022/050798

§ 371 Date: Sep. 29, 2023

(30) Foreign Application Priority Data
Apr. 1, 2021 (GB) 2104741.0

(51) Int. Cl. H05H 1/34; H05H 1/00

(52) U.S. Cl. CPC H05H 1/3425; H05H 1/0037

(57) ABSTRACT

Aspects relate to monitorable plasma torch device components and in particular to monitoring and predictive maintenance of one or more such monitorable plasma torch device components. One aspect provides a monitorable plasma torch device component, the component comprising: a component body and a sacrificial component located in an erosion zone of the component body. The sacrificial component comprises material which differs from the plasma torch device component body and which, on exposure to a plasma torch in a plasma torch device, generates electromagnetic radiation distinct from that of the plasma torch device component body. The distinct electromagnetic radiation generated is indicative of erosion of the monitorable plasma torch device component in the erosion zone. Such a monitorable plasma torch device component can facilitate effective component monitoring which allows for ameliorative action to be taken in the event that degradation of the device component is detected.

### CROSS-REFERENCE OF RELATED APPLICATION

This application is a Section 371 National Stage Application of International Application No. PCT/GB2022/050798, filed Mar. 30, 2022, and published as WO 2022/208082A1 on Oct. 6, 2022, the content of which is hereby incorporated by reference in its entirety and which claims priority of British Application No. 2104741.0, filed Apr. 1, 2021.

### FIELD

The field of the invention relates to monitorable plasma torch device components, and in particular, to monitoring and predictive maintenance of one or more such monitorable plasma torch device components.

### BACKGROUND

In some manufacturing industries, for example, the semiconductor or flat panel display manufacturing industry, effluent gas streams may be produced by a manufacturing process tool. Residual fluorinated or perfluorinated compounds (PFCs) and other compounds exist in the effluent gas stream pumped from the process tool. These compounds are difficult to remove from the effluent gas stream and their release into the environment is undesirable because they are known to have relatively high greenhouse activity.

One approach to remove the PFCs and other compounds from the effluent gas stream is to use a radiant burner. However, when fuel gases normally used for abatement by combustion are undesirable or not readily available, it is also known to use a plasma torch abatement device.

Plasmas for abatement devices can be formed in a variety of ways. The plasma generated by a plasma abatement device is used to destroy or abate unwanted compounds within the effluent gas stream. Plasma torch abatement devices can be particularly useful in environments subject to flammability constraints, can be cost effective and may offer advantages in terms of installation when compared to radiant burner devices.

Typically an effluent gas stream originates from a manufacturing tool and the abatement process is interlocked with operation of the manufacturing tool. It is helpful to users of manufacturing tools which utilise abatement devices to be able to provide predictable uptime. All abatement devices require maintenance to maintain efficient operation. Accordingly, it is desired to provide an improved technique for monitoring the health of one or more components of a plasma abatement device, for example, such that maintenance of the abatement device can be scheduled to fit with manufacturing tool operation and/or maintenance can be performed when it is required.

The discussion above is merely provided for general background information and is not intended to be used as an aid in determining the scope of the claimed subject matter. The claimed subject matter is not limited to implementations that solve any or all disadvantages noted in the background.

### SUMMARY

A first aspect provides a monitorable plasma torch device component; the component comprising a component body and a sacrificial component located in an erosion zone of the component body; the sacrificial component comprising material which differs from the plasma torch device component body and which, on exposure to a plasma torch in a plasma torch device, generates electromagnetic radiation distinct from that of the plasma torch device component body indicative of erosion of the monitorable plasma torch device component in the erosion zone.

Aspects recognise that health and/or operating state of one or more components of a plasma abatement device can be monitored by observation of optical emissions from atomic species generated by decomposition of the component material. Such emissions can be observed, for example, by using an Optical Emission Spectrometer (OES). An increase in specific species emissions can be indicative of indicative of excess wear of a component. Aspects recognise that provision of a monitorable plasma abatement device component can facilitate efficient monitoring methods. For example, an increase in specific species emissions can be indicative of detection of an embedded sacrificial component included in the body of a plasma abatement device component, for example, a component forming part of an abatement reaction chamber or a component forming at least part of a plasma torch nozzle. Detection of those specific species emissions or a change in expected specific species emissions can permit instigation of a warning or signal indicative that action may be required, timely prediction of maintenance of the plasma torch device and/or remedial action, for example, torch power reduction, to prolong component life, and/or shift maintenance or downtime to allow ongoing use of a manufacturing tool which the plasma device supports.

In some arrangements, the monitorable plasma torch device component comprises: a reaction chamber comprising one or more sacrificial component embedded within a wall of the reaction chamber.

In some arrangements, the monitorable plasma torch device component comprises: an anode comprising one or more sacrificial component embedded within the anode.

In some arrangements, the monitorable plasma torch device component comprises: a mixing cone comprising one or more sacrificial component embedded within the mixing cone.

In some arrangements, the sacrificial component is selected to have signature electromagnetic radiation, when excited by a plasma, distinct to one or more of: electromagnetic radiation of other components of the plasma torch device; a plasma forming gas or an effluent stream processable by the plasma torch device.

In some arrangements, the sacrificial component is selected to have signature electromagnetic radiation, when excited by a plasma, distinct to electromagnetic radiation of effluent gas to be processed by the plasma torch device.

In some arrangements, the sacrificial component comprises: a sacrificial layer.

In some arrangements, the sacrificial component comprises: one or more sacrificial rods.

In some arrangements, at least a portion of the sacrificial component is located in a region of a component where, in use within a plasma torch device, erosion of the monitorable plasma torch device component is expected.

In some arrangements, the monitorable plasma torch device component includes at least two different sacrificial components, each located in a different erosion zone of the component body where, in use within a plasma torch device, erosion of the monitorable plasma torch device body is expected.

In some arrangements, the at least two different sacrificial components each comprise differing materials each of which generates electromagnetic radiation distinct from that of the plasma torch device component body indicative of erosion of the monitorable plasma torch device component in the different erosion zones.

In some arrangements, the electromagnetic radiation generated by the plasma torch comprises: emission from volatilised material associated with the sacrificial component and detection of that emission is associated with failure of the monitorable component of the plasma torch device.

In some arrangements, the plasma torch device comprises: a plasma torch abatement device.

In some arrangements, the electromagnetic radiation generated comprises: optical emission.

A second aspect provides a method of monitoring plasma torch device component; the component comprising a component body and a sacrificial component located in an erosion zone of the component body; the sacrificial component comprising material which differs from the plasma torch device component body; the method comprising: exposing the plasma torch device component to a plasma torch in a plasma torch device; collecting electromagnetic radiation generated by the plasma torch in the plasma torch device; analysing the collected electromagnetic radiation generated by the plasma torch to monitor for electromagnetic radiation generated by the sacrificial component distinct from that of the plasma torch device component body and indicative of erosion of the monitorable plasma torch device component in the erosion zone.

In some arrangements, the method comprises: comparing the collected electromagnetic radiation to known electromagnetic radiation associated with the component body; and triggering one or more actions in the event that the collected emission differs from the known emission.

In some arrangements, the electromagnetic radiation comprises: optical emission spectra obtained from the collected electromagnetic radiation generated by the plasma torch.

In some arrangements, the electromagnetic radiation generated by the sacrificial component distinct from that of the plasma torch device component body comprises: a characteristic intensity.

In some arrangements, the electromagnetic radiation generated by the sacrificial component distinct from that of the plasma torch device component body comprises: emission characteristic of a material forming at least part of the sacrificial component.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 illustrates main components of a plasma abatement apparatus;

FIGS. 2A to 2F illustrate schematically arrangements in which sacrificial material forms part of a reaction chamber and erosion of a reaction chamber to activate the sacrificial material;

FIGS. 3A to 3D illustrate schematically arrangements in which sacrificial material forms part of a nozzle cone and erosion of a nozzle cone to activate the sacrificial material;

FIGS. 4A to 4D illustrate schematically arrangements in which sacrificial material forms part of an anode and erosion of an anode to activate the sacrificial material; and

FIG. 5 illustrates example spectra and change in such spectra if component erosion is detected.

### DETAILED DESCRIPTION

Before discussing the embodiments in any more detail, first an overview will be provided.

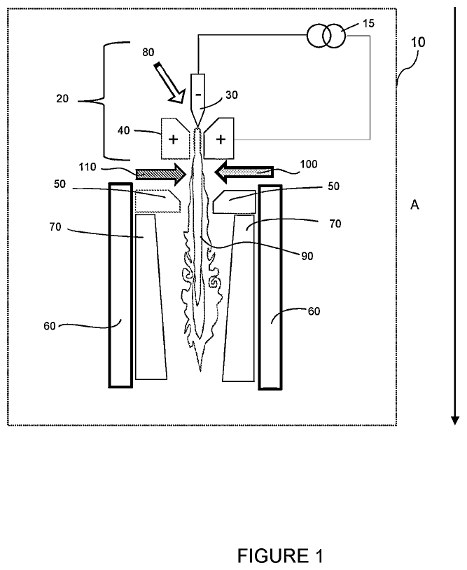

FIG. 1 illustrates a plasma abatement apparatus, generally 10, according to one embodiment. The plasma abatement apparatus has a plasma torch 20 comprising a cathode 30 and an anode 40. The anode 40 comprises an annular structure which defines a tubular void, with the cathode 30 being coaxially aligned with an elongate axis of that tubular void.

A nozzle, also known as a mixing cone, 50 is coaxially aligned with the plasma torch 20, located further along the elongate axis, away from the anode 40. The mixing cone 50 also comprises an annular structure defining a tubular conduit extending along the elongate axis.

The mixing cone 50 is received within a concentrically-surrounding casing 60 which defines a reaction chamber 70.

In operation, a plasma-forming gas stream 80 is introduced between the cathode 30 and the anode 40 which are electrically charged and undergo a DC arc discharge to generate a plasma stream 90 which flows in a direction of flow A which is aligned with the elongate axis. The plasma stream 90 flows through the tubular conduit of the anode 40 and exits towards the mixing cone 50. An effluent gas stream 100, typically together with a fluid reagent stream, for example, compressed dried air, 110, enters the tubular conduit of the mixing cone 50. The combined plasma stream 90, effluent gas stream 100 and fluid reagent 110 travel through the mixing cone 50 towards the reaction chamber 70 and enter the reaction chamber 70 where abatement of compounds within the effluent gas stream 100 occurs.

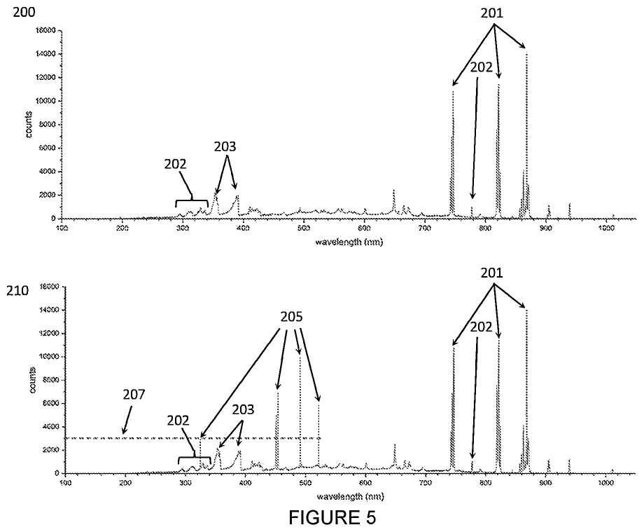

Arrangements recognise that plasma generating methods, including DC arc and Inductively Coupled Plasma (ICP) can be used to volatilise material samples and that optical emission spectroscopy can be used to determine composition of such material samples. The ability of the plasma to generate excited species which emit characteristic spectra can be utilised to implement a method by which the condition or health of one or more operating component of a plasma abatement system can be monitored. FIG. 5 illustrates the principles of spectral monitoring which underlie operation of all possible arrangements.

Example components which can be monitored in a plasma abatement system include, for example, an anode in a DC Plasma system. If an anode, typically made from copper or tungsten or an alloy of the two, starts to be eroded, for example, by chemical attack or by operation of the plasma itself as a result of excessively localised arc attachment, material is discharged into the plasma stream. That discharged material can be excited by the plasma such that it emits characteristic emission spectra relating to the construction material.

It is possible to detect that emission spectra, for example, by providing an optical sensor, which can be radially located, and in the line of sight of the plasma stream. It will be appreciated that even a healthy anode will typically discharge a small flux of material and therefore generate a small background spectra of atomic emission relating to the material of anode construction. A rise in intensity of the background spectra signal above a predetermined threshold level may be used as an indication of decreased anode health and to trigger warnings of, for example, impending maintenance requirements or remedial actions including reduction of plasma torch power to reduce anode erosion rate and lengthen plasma torch life.

Example components which can be monitored in a plasma abatement system may also include an abatement reaction chamber. A reaction chamber usually comprises: a cylindrical reactor also known as a reaction tube. The reactor can be made of stainless steel (SS), inert materials such as hastelloy (HA) and/or ceramic-based materials featuring alumina (AL).

If monitoring health status of the reactor, one or more action can be triggered in dependence upon a trend or value in emission intensity of atoms indicative of reactor wear, for example, iron (SS), nickel, molybdenum, chromium (HA) and/or aluminium (AL).

Further example components which can be monitored in a plasma abatement system may include the mixing cone 50, and system.

Whilst, as described above, it is possible to monitor for a trend or value in emission intensity of atoms indicative of component wear based solely upon a material from which various components are usually formed, described arrangements recognise that one or more components of the system may include a sacrificial layer or one or more sacrificial element formed from a material with a distinctive emission spectra. By including such a sacrificial component inserted, embedded or formed within a component of a plasma abatement device, it becomes possible to monitor emission spectra occurring within the abatement device and to recognise erosion of one or more device components when a distinctive emission spectrum associated with a sacrificial element is detected. In one possible example, different components of the system may have sacrificial components or elements included such that their erosion signature may differ from that of any other component. This may result from appropriate component material choice and/or appropriate sacrificial element choice in relation to each component to be monitored.

In one possible example of use of a sacrificial component within a component of the system, a sacrificial layer is embedded underneath a surface of the reaction chamber in the region of the reaction chamber typically exposed to a plasma torch. Erosion of a reaction chamber tube typically proceeds in an outward concentric manner so appropriate location of the sacrificial layer or element can mean that detection of a different emission line will be triggered if erosion reaches that appropriately located embedded sacrificial layer. For a SS reactor a trapped Al layer can be embedded, while a ferrous material may be preferred for a HA tube. Ca is a strong emitter and can be embedded easily in ceramic-based tube by adding it to preparation recipe. Detection of the emission line(s) associated with the sacrificial layer are an indication of component wear. Detection of an emission line may pass a preselected intensity threshold or display a preselected trend on increase in intensity, and trigger a maintenance warning or similar indication that the component or system may require attention or maintenance.

Methods and arrangements described may facilitate timely detection of component wear within a plasma abatement device. For example, methods and arrangements may provide a mechanism to detect excessive anode wear in a DC plasma torch and/or erosion of the reaction chamber and/or erosion or wear of a mixing cone and/or erosion or wear of the system seals

Primary life-limiting failure modes for DC Plasma torch abatement systems include: component wear due to a combination of melting as a result of excessively localised arc attachment and erosion induced by plasma-induced physical sputtering or by chemical attack. Optical emission spectroscopy approaches can provide a mechanism to monitor the plasma and provide a qualitative and/or quantitative measurement of the concentration of metallic species in a plasma stream. The concentrations detected by optical emission spectroscopy may, for example, be directly correlated to wear of an anode, reaction chamber, mixing cone, seal or other component of the plasma abatement system.

Various example implementations are now described in more detail:

In general a plasma abatement apparatus operates such that a power supply applies a voltage potential V between a cathode and an anode at a substantial current I to sustain a plasma forming arc. A supply of plasma forming gas passes between the cathode and anode. The gas supply is introduced at a regulated flow, for example, via a mass-flow controller. The plasma forming gas is heated and ionised by the plasma forming arc to form a plasma stream.

According to some arrangements, optical emission from the plasma stream is collected by a lens and focused on a suitable optical detector. A signal from the detector can be used by a control system.

The control system can be configured to use an algorithm to analyse a signal from the detector. In some arrangements, operation of the plasma abatement apparatus is adjustable in dependence upon the algorithm implemented by the control system and a detected relative concentration of one or more emitting species as determined from the signal from the detector.

In some arrangements, the control system can be configured to adjust operation of the plasma abatement apparatus by adjusting power supply voltage V via a control signal sent to the power supply. That control signal may result in a change in discharge current I applied between anode and cathode. The control system may also, or alternatively, be configured to adjust the flow of plasma forming gas via a control signal sent to the mass-flow controller. That control signal may result in a mass flow change, which in turn regulates voltage. For a DC arc torch the power supply unit typically delivers a constant current while voltage can be regulated by plasma gas flow. The plasma arc position and discharge voltage can be regulated by the plasma-forming gas flow. By adjusting the operating characteristics of the system, component life may be extended, allowing for continued operation of the abatement platform in support of a manufacturing process, until more a more appropriate time for disruptive maintenance associated with component replacement.

It will be appreciated that in some cases, optical emissions from the plasma stream are monitored upstream of an abatement chamber in which a process gas stream is mixed with the plasma stream. As a result, the optical emissions and associated observations can be largely independent of any material forming part of the abatement process.

In relation to erosion or wear detection, the collected emission spectra may be analysed to detect emission line(s) associated with wear of one or more components. That wear may be detected as a result of detection of emission line(s) associated with a sacrificial layer or element located in, for example, the mixing nozzle or reaction chamber, either of which can provide an indication of component wear. Detection of an emission line associated with wear of the nozzle or chamber may, for example, pass a preselected intensity threshold and/or show a preselected trend and trigger a maintenance warning or similar indication that the component or system require attention.

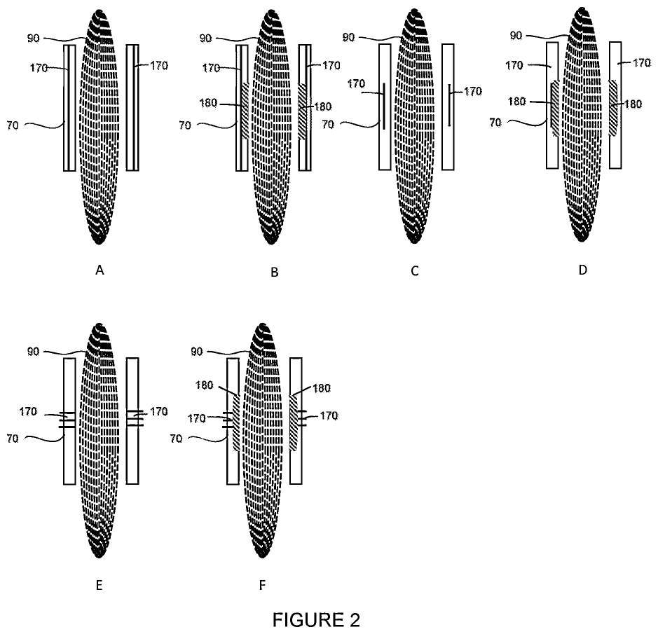

FIGS. 2A to 2F illustrate schematically arrangements in which sacrificial material forms part of a reaction chamber and erosion of a reaction chamber to activate the sacrificial material. FIG. 2 illustrates some non-comprehensive examples regarding provision of a sacrificial component 170 in the form of, for example, a layer and/or sacrificial element within a reaction chamber 70. FIG. 2A illustrates an arrangement in which a sacrificial component 170 in the form of a layer is embedded in a wall of the reaction chamber 70. In the example shown, the sacrificial layer 170 is distributed along substantially the entire length of the reaction chamber 70. FIG. 2B illustrates the manner in which a sacrificial layer such as that provided in FIG. 2A can revealed by the effect of concentric erosion 180 of the cylindrical chamber 70 by the plasma plume 90.

In FIG. 2C and 2D the sacrificial component 170 extends along an annular region embedded within the wall of the reaction chamber 70. The sacrificial layer 170 in this example has been located where the concentric erosion 180 of a plasma plume 90 is likely to occur.

FIGS. 2E and 2F illustrate schematically an arrangement in which a sacrificial component 170 takes the form of one or more rods running radially through the wall of the reaction chamber. A multiplicity of the sacrificial material rods 170 may be employed. In the example shown, the radial sacrificial rods may be provided primarily in the plasma plume erosion zone 180.

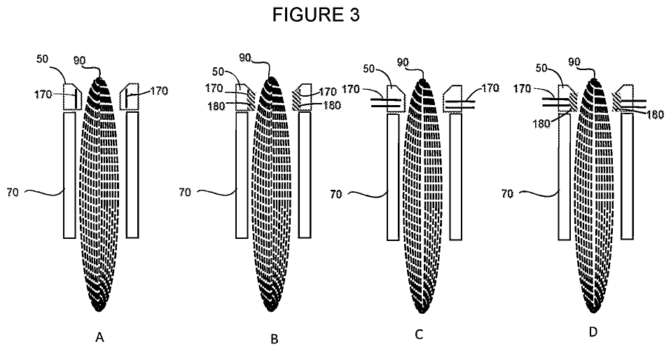

FIGS. 3A to 3D illustrate schematically arrangements in which sacrificial material forms part of a mixing cone and erosion of a nozzle cone to activate the sacrificial material. FIG. 3A illustrates a mixing cone 50 in which sacrificial material extends along a length of the cone at a fixed radial depth from an inner surface. FIG. 3B illustrates schematically how erosion of the mixing cone could expose the sacrificial material. FIG. 3C illustrates a mixing cone 50 in which sacrificial elements extend radially from an inner surface of the cone. FIG. 3D illustrates schematically how erosion of the mixing cone could expose the sacrificial material.

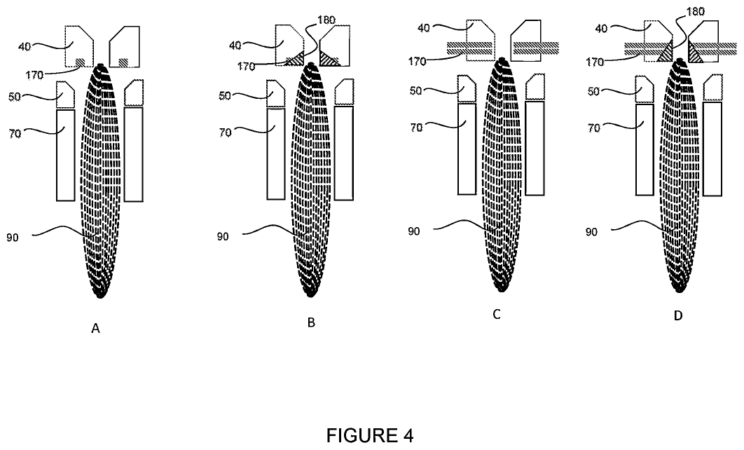

FIGS. 4A to 4D illustrate schematically arrangements in which sacrificial material forms part of an anode and erosion of an anode to activate the sacrificial material. The examples of FIG. 4 show arrangements in which sacrificial material can be included in an anode 40. Typically an anode may be formed from copper. If made of copper, inclusion of silver as a sacrificial material may be useful. FIG. 4A illustrates an anode 40 in which sacrificial material, for example, silver, extends along a length of the anode at a fixed radial depth. FIG. 4B illustrates schematically how erosion of the anode could expose the sacrificial material. FIG. 4C illustrates an anode 40 in which sacrificial elements extend radially. FIG. 4D illustrates schematically how typical erosion of an anode could expose the sacrificial material. The arrangement of FIG. 4A can be advantageous to detect anode erosion when critical along the anode radius. The arrangement of FIG. 4C can be advantageous to detect anode erosion when the erosion depth is critical.

FIG. 5 illustrates example spectra and change in such spectra if component erosion is detected. FIG. 5 shows signature spectra associated with a plasma abatement system and an instance of an anomalous spectra which may be detected. The spectra may, for example, be associated with an arrangement in which an anode is formed from copper. It can be seen that the anomalous spectra includes a Cu spectral line, which may, for example, be associated with wear of an anode in a system. In particular, FIG. 5 illustrates examples of electronic emission spectra which can be used to identify anomalous erosion of a copper anode in a DC arc torch. In FIG. 5 normal emission spectra 200 associated with a plasma abatement device is shown adjacent to an anomalous emission spectra 210 in which a copper anode has begun to erode. In both the normal 200 and anomalous spectra 210, spectral lines related to atomic nitrogen 201, spectral lines related to atomic oxygen 202, spectral lines related to molecular nitrogen 203 and spectral lines related to copper 205, from which the anode is formed, can be seen. A threshold value 207 relating to emission intensity threshold for copper emission is shown. If copper spectral lines reach this level, then ameliorative or maintenance action can be taken, or a warning triggered. Analogous analysis can be performed in relation to the monitoring for one or more emission line associated with a material forming a sacrificial component.

TABLE 1

| Elements | Emission spectra; examples of intense peaks |
|---|---|
| Cu (I, II | 306.3, 324.8, 327.4, 402.3, 406.3, 424.9, 427.5, |
| ionisation) | 450.9, 454.0, 458.7, 465.1, 491.0, 491.8, 493.2, |
| | 495.4, 505.2, 515.3, 521.8, 522.0, 529.3 |
| Ag (I, II | 328.1, 338.3, 421.1, 520.9, 540.0, 540.3, 546.5, |
| ionisation) | 548.8, 555.2, 561.1, 562.2, 768.8, 827.4, 840.4 |
| Fe (I, II | 300.3, 317.8, 321.1, 322.8, 344.1, 347.5, 349.1, |
| ionisation) | 363.1, 368.3, 370.6, 372.3, 373.3, 374.6, 374.9, |
| | 382.4, 385.6, 387.9, 390.0, 392.3, 393.0, 404.6, |
| | 434.8, 526.0, 527.0 |
| Ca (I, II | 315.9, 317.9, 318.1, 370.6, 373.7, 393.4, 396.8, |
| ionisation) | 422.7, 445.5, 585.7, 616.2, 643.9, 645.0, 646.3, |
| | 649.4, 671.8, 820.2, 824.9, 849.8, 854.2, 866.2 |
| Al (I, II | 302.7, 304.1, 305.0, 305.7, 307.5, 308.2, 308.9, |
| ionization) | 309.3, 394.4, 396.2, 458.6, 466.3, 555.7, 559.3, |
| | 669.6, 669.9, 783.5, 783.6, 877.4, 884.1 |

Table 1 provides an indication of emission peaks associated with various elements which may be used to form components of a device, or which may be chosen for use as a sacrificial element for inclusion within one or more components of a device.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A monitorable plasma torch device component comprising:
a component body and a sacrificial component located in an erosion zone of the component body;
the sacrificial component comprising material which differs from the plasma torch device component body and which, on exposure to a plasma torch in a plasma torch device, generates electromagnetic radiation distinct from that of the plasma torch device component body indicative of erosion of the monitorable plasma torch device component in the erosion zone.

2. The monitorable plasma torch device component according to claim 1 comprising: a reaction chamber comprising one or more sacrificial component embedded within a wall of the reaction chamber.

3. The monitorable plasma torch device component according to claim 1 comprising: an anode comprising one or more sacrificial component embedded within the anode.

4. The monitorable plasma torch device component according to claim 1 comprising: a mixing cone comprising one or more sacrificial component embedded within the mixing cone.

5. The monitorable plasma torch device component according to claim 1, in which the sacrificial component is selected to have signature electromagnetic radiation, when excited by a plasma, distinct to one or more of: electromagnetic radiation of other components of a plasma torch device; a plasma forming gas or an effluent stream processable by the plasma torch device.

6. The monitorable plasma torch device component according to claim 1, in which the sacrificial component is selected to have signature electromagnetic radiation, when excited by a plasma, distinct to electromagnetic radiation of effluent gas to be processed by a plasma torch device.

7. The monitorable plasma torch device component according to claim 1, in which the sacrificial component comprises: a sacrificial layer.

8. The monitorable plasma torch device component according to claim 1, in which the sacrificial component comprises: one or more sacrificial rods.

9. The monitorable plasma torch device component according to claim 1, wherein at least a portion of the sacrificial component is located in a region of a component where, in use within a plasma torch device, erosion of the monitorable plasma torch device component is expected.

10. The monitorable plasma torch device component according to claim 1, wherein the monitorable plasma torch device component includes at least two different sacrificial components, each located in a different erosion zone of the component body where, in use within a plasma torch device, erosion of the monitorable plasma torch device body is expected.

11. The monitorable plasma torch device component according to claim 10, wherein the at least two different sacrificial components each comprise differing materials each of which generates electromagnetic radiation distinct from that of the plasma torch device component body indicative of erosion of the monitorable plasma torch device component in the different erosion zones.

12. The monitorable plasma torch device component according to claim 1, wherein the electromagnetic radiation generatable by the plasma torch comprises: emission from volatilised material associated with the sacrificial component and detection of that emission is associated with failure of the monitorable component of the plasma torch device.

13. The monitorable plasma torch device component according to claim 1, wherein the plasma torch device comprises: a plasma torch abatement device.

14. The monitorable plasma torch device component according to claim 1, wherein the electromagnetic radiation generated comprises: optical emission.

15. A method of monitoring a plasma torch device component; the component comprising a component body and a sacrificial component located in an erosion zone of the component body; the sacrificial component comprising material which differs from the plasma torch device component body; the method comprising:
exposing the plasma torch device component to a plasma torch in a plasma torch device;
collecting electromagnetic radiation generated by the plasma torch in the plasma torch device;
analysing the collected electromagnetic radiation generated by the plasma torch to monitor for electromagnetic radiation generated by the sacrificial component distinct from that of the plasma torch device component body and indicative of erosion of the monitorable plasma torch device component in the erosion zone.
